(19) United States
(12) Patent Application Publication
(10) Pub. No.: US 2013/0040666 A1
(43) Pub. Date: Feb. 14, 2013

(54) METHODS AND APPARATUS FOR SCHEDULING PAGING MONITORING INTERVALS IN A MULTIMODE MOBILE STATION

(71) Applicants: Tom Chin, San Diego, CA (US); Guangming Shi, San Diego, CA (US); Kuo-Chun Lee, San Diego, CA (US); Steven D. Cheng, San Diego, CA (US)

(72) Inventors: Tom Chin, San Diego, CA (US); Guangming Shi, San Diego, CA (US); Kuo-Chun Lee, San Diego, CA (US); Steven D. Cheng, San Diego, CA (US)

(73) Assignee: QUALCOMM Incorporated, San Diego, CA (US)

(21) Appl. No.: 13/283,277

(22) Filed: Oct. 27, 2011

Related U.S. Application Data
(60) Provisional application No. 61/522,108, filed on Aug. 10, 2011.

(51) Int. Cl. H04W 68/00

(52) U.S. Cl. 455/458

(57) ABSTRACT

Certain aspects of the present disclosure present methods and apparatus for resolving conflict between paging intervals of two different networks. For certain aspects, a multimode mobile station (MS) may select a network for monitoring based on a predefined criterion. For an aspect, the multimode MS may select a network whose paging interval starts earlier or a network whose paging interval finishes earlier. The multimode MS may also select a network that has a higher signal quality, or higher radio access technology (RAT)-based priority. In another aspect, if the multimode MS uses multiple input multiple output (MIMO), the multimode MS may split its available resources (e.g., receive chains) to simultaneously monitor paging signals transmitted by both networks.

### CLAIM OF PRIORITY UNDER 35 U.S.C. §119

The present application for patent claims priority to U.S. Provisional Application No. 61/522,108, entitled, “Methods and Apparatus for Scheduling Paging Monitoring Intervals in a Multimode Mobile Station,” filed Aug. 10, 2011, and assigned to the assignee hereof, which is hereby expressly incorporated by reference herein.

### TECHNICAL FIELD

Certain aspects of the present disclosure generally relate to wireless communication and, more particularly, to scheduling paging monitoring intervals in a multimode mobile station.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Worldwide Interoperability for Microwave Access (WiMAX).

As the demand for mobile broadband access continues to increase, research and development continue to advance the UMTS technologies not only to meet the growing demand for mobile broadband access, but to advance and enhance the user experience with mobile communications.

### SUMMARY

Certain aspects of the present disclosure provide a method for communicating, by a multi-mode mobile station (MS), with first and second networks via first and second radio access technologies (RATs), respectively. The method generally includes determining that an overlap will occur between a first paging interval of the first network and a second paging interval of the second network, selecting between the first and second paging intervals based on at least one parameter associated with the first and second paging intervals, and detecting a message associated with paging based on the selected paging interval.

Certain aspects of the present disclosure provide a method for communicating, by a multi-mode mobile station (MS), with first and second networks via first and second radio access technologies (RATs), respectively. The method generally includes determining that an overlap will occur between a first paging interval of the first network and a second paging interval of the second network, and monitoring the first paging interval with a first receive chain and monitoring the second paging interval with a second receive chain during the overlap.

Certain aspects of the present disclosure provide an apparatus for communicating with first and second networks via first and second radio access technologies (RATs), respectively. The apparatus generally includes means for determining that an overlap will occur between a first paging interval of the first network and a second paging interval of the second network, means for selecting between the first and second paging intervals based on at least one parameter associated with the first and second paging intervals, and means for detecting a message associated with paging based on the selected paging interval.

Certain aspects of the present disclosure provide an apparatus for communicating with first and second networks via first and second radio access technologies (RATs), respectively. The apparatus generally includes means for determining that an overlap will occur between a first paging interval of the first network and a second paging interval of the second network, and means for monitoring the first paging interval with a first receive chain and monitoring the second paging interval with a second receive chain during the overlap.

Certain aspects provide a computer-program product for communicating, by a multi-mode mobile station (MS), with first and second networks via first and second radio access technologies (RATs), respectively. The computer-program product comprising a computer-readable medium having instructions stored thereon, the instructions being executable by one or more processors. The instructions generally include instructions for determining that an overlap will occur between a first paging interval of the first network and a second paging interval of the second network, instructions for selecting between the first and second paging intervals based on at least one parameter associated with the first and second paging intervals, and instructions for detecting a message associated with paging based on the selected paging interval.

Certain aspects provide a computer-program product for communicating, by a multi-mode mobile station (MS), with first and second networks via first and second radio access technologies (RATs), respectively. The computer-program product comprising a computer-readable medium having instructions stored thereon, the instructions being executable by one or more processors. The instructions generally include instructions for determining that an overlap will occur between a first paging interval of the first network and a second paging interval of the second network, and instructions for monitoring the first paging interval with a first receive chain and monitoring the second paging interval with a second receive chain during the overlap.

Certain aspects of the present disclosure provide an apparatus for communicating with first and second networks via first and second radio access technologies (RATs), respectively. The apparatus generally includes at least one processor and a memory coupled to the at least one processor. The at least one processor configured to determine that an overlap will occur between a first paging interval of the first network and a second paging interval of the second network, select between the first and second paging intervals based on at least one parameter associated with the first and second paging intervals, and detect a message associated with paging based on the selected paging interval.

Certain aspects of the present disclosure provide an apparatus for communicating with first and second networks via first and second radio access technologies (RATs), respectively. The apparatus generally includes at least one processor and a memory coupled to the at least one processor. The at least one processor determine that an overlap will occur between a first paging interval of the first network and a second paging interval of the second network, and monitor the first paging interval with a first receive chain and monitoring the second paging interval with a second receive chain during the overlap, and a memory coupled to the at least one processor.

### BRIEF DESCRIPTION OF THE DRAWINGS

So that the manner in which the features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example wireless communication system, in accordance with certain aspects of the present disclosure.

FIG. 2 illustrates various components that may be utilized in a wireless device in accordance with certain aspects of the present disclosure.

FIG. 3 illustrates an example transmitter and an example receiver that may be used within a wireless communication system that utilizes orthogonal frequency-division multiplexing/multiple access (OFDM/OFDMA) technology in accordance with certain aspects of the present disclosure.

FIG. 4 illustrates an example worldwide interoperability for microwave access (WiMAX) network overlaid with an example code division multiple access (CDMA) network, in accordance with certain aspects of the present disclosure.

FIG. 5 illustrates an example paging interval conflict between a WiMAX network and a CDMA network, in accordance with certain aspects of the present disclosure.

FIG. 6 illustrates example operations that may be executed to schedule monitoring of paging intervals in a multimode mobile station that can tune to different frequencies, whenever there is a conflict between paging intervals of two different networks, in accordance with certain aspects of the present disclosure.

FIG. 7 illustrates an example paging interval conflict resolution by splitting multiple input multiple output (MIMO) resources between two networks when a paging conflict is about to happen, in accordance with certain aspects of the present disclosure.

FIG. 8 illustrates an example paging interval conflict resolution by splitting MIMO resources between two networks after a paging conflict happens, in accordance with certain aspects of the present disclosure.

FIG. 9 illustrates example operations that may be executed to schedule monitoring of paging intervals in a multimode mobile station, whenever there is a conflict between paging intervals of two different networks, in accordance with certain aspects of the present disclosure.

FIG. 10 illustrates scheduling a paging interval during a paging interval conflict between two different networks based on paging interval of a network that starts earlier or ends earlier, in accordance with certain aspects of the present disclosure.

FIG. 11 illustrates scheduling a paging interval during a paging interval conflict between two different networks based on signal quality of the networks, in accordance with certain aspects of the present disclosure.

FIG. 12 illustrates scheduling a paging interval during a paging interval conflict between two different networks by selecting a network that was not selected during a previous paging interval conflict, in accordance with certain aspects of the present disclosure.

FIG. 13 illustrates scheduling a paging interval during a paging interval conflict between two different networks based on radio access technology (RAT)-based priorities of the networks, in accordance with certain aspects of the present disclosure.

FIG. 14 illustrates an example communication system, in accordance with certain aspects of the present disclosure.

### DETAILED DESCRIPTION

Certain aspects are described herein with reference to the drawings, wherein like reference numerals are used to refer to like elements throughout. In the following description, for purposes of explanation, numerous specific details are set forth in order to provide a thorough understanding of certain aspects. However, it may be that such aspect(s) can be practiced without these specific details. In other instances, well-known structures and devices are shown in block diagram form in order to facilitate describing certain aspects.

### An Example Wireless Communication System

The techniques described herein may be used for various broadband wireless communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems, and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

One example of a communication system based on an orthogonal multiplexing scheme is a WiMAX system. WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX is based on OFDM and OFDMA and offers the full mobility of cellular networks at broadband speeds.

IEEE 802.16 is an emerging standard organization to define an air interface for fixed and mobile broadband wireless access (BWA) systems. These standards define at least four different physical layers (PHYs) and one media access control (MAC) layer. The OFDM and OFDMA physical layer of the four physical layers are the most popular in the fixed and mobile BWA areas respectively.

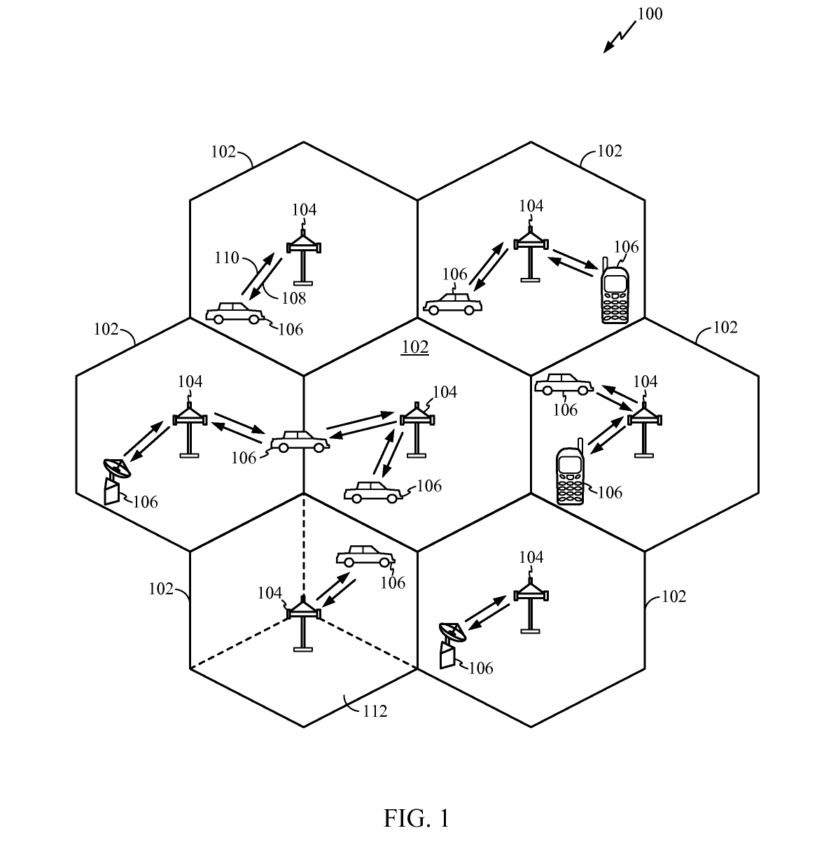

FIG. 1 illustrates an example of a wireless communication system 100 in which certain aspects of the present disclosure may be employed. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. User terminals 106 may be fixed (i.e., stationary) or mobile. User terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers, etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

Cell 102 may be divided into multiple sectors 112. Sector 112 is a physical coverage area within a cell 102. Base stations 104 within a wireless communication system 100 may utilize antennas that concentrate the flow of power within a particular sector 112 of the cell 102. Such antennas may be referred to as directional antennas.

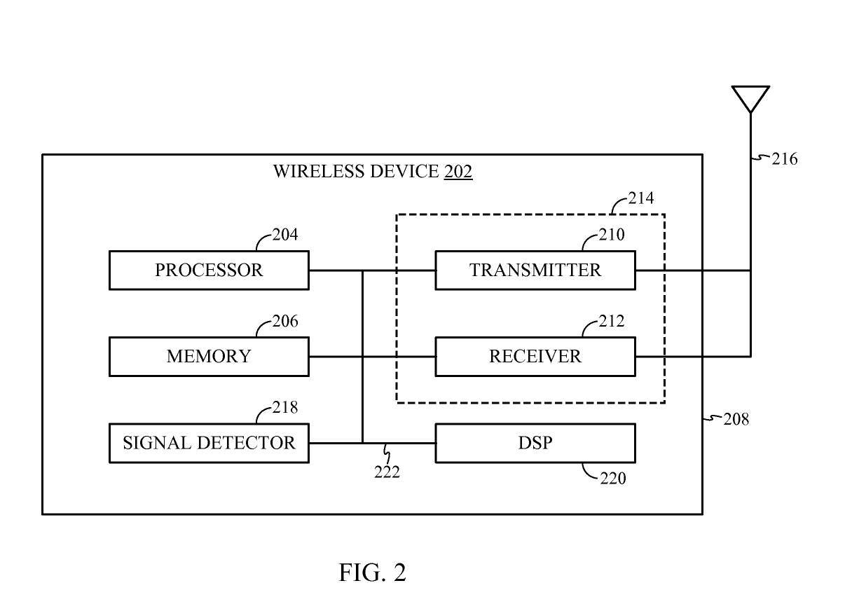

FIG. 2 illustrates various components that may be utilized in a wireless device 202 that may be employed within the wireless communication system 100. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to processor 204. A portion of memory 206 may also include non-volatile random access memory (NVRAM). Processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy per pseudonoise (PN) chips, power spectral density and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

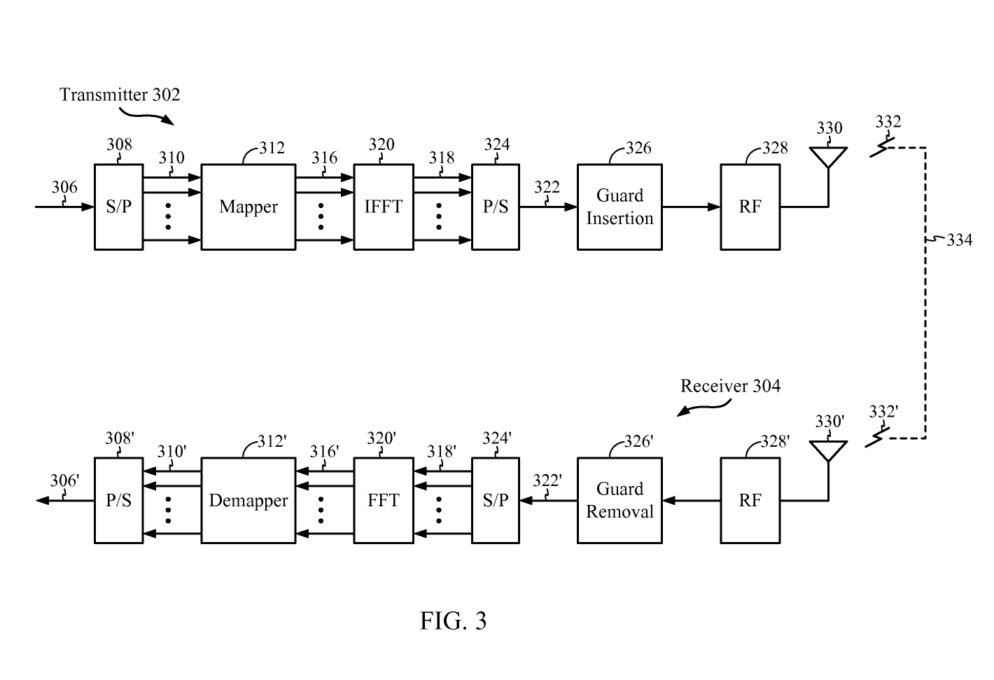

FIG. 3 illustrates an example of a transmitter 302 that may be used within a wireless communication system 100 that utilizes OFDM/OFDMA. Portions of transmitter 302 may be implemented in transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), and the like. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Ns, is equal to Ncp (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless device 202 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312 thereby outputting N parallel data streams 310′. A P/S converter 308′ may combine the N parallel data streams 310′ into a single data stream 306′. Ideally, this data stream 306′ corresponds to the data 306 that was provided as input to the transmitter 302. Note that elements 308′, 310′, 312′, 316′, 320′, 318′ and 324′ may all be found in a baseband processor.

### An Example Method to Schedule Paging Monitoring Intervals in a Multimode Mobile Station

Certain aspects of the present disclosure present methods and apparatuses for resolving conflict between paging intervals of two different networks. For certain aspects, a multimode mobile station (MS) may select a network for monitoring based on a predefined criterion. For an aspect, the multimode MS may select a network whose paging interval starts earlier or a network whose paging interval finishes earlier. The multimode MS may also select a network that has a higher signal quality, or higher radio access technology (RAT)-based priority. In another aspect, if the multimode MS uses multiple input multiple output (MIMO), the multimode MS may split its available resources (e.g., receive chains) to simultaneously monitor paging signals transmitted by both networks.

In deployment of broadband services, a Worldwide Interoperability for Microwave Access (WiMAX) network may be overlaid with an existing CDMA or Universal Mobile Telecommunications System (UMTS) network to provide simultaneous operation. Some mobile stations may be able to support communications with multiple RATs in order to expand their available services. For example, a multimode mobile station may support WiMAX and CDMA 1xRTT (Radio Transmission Technology) for voice and broadband data services.

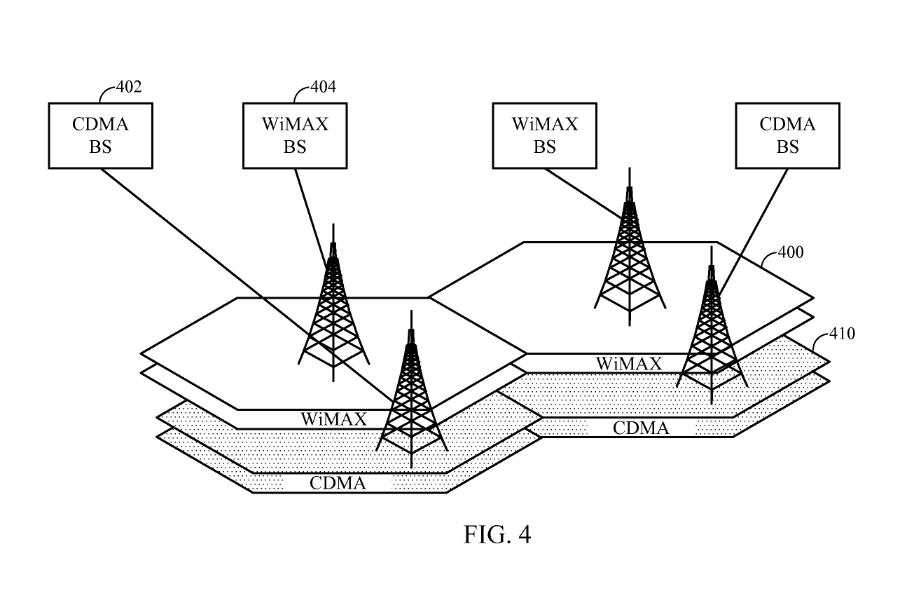

FIG. 4 illustrates an example WiMAX network 400 overlaid with an example CDMA network 410. The WiMAX network may also be overlaid with any other types of networks such as UMTS, or the like. A multi-mode MS may communicate with the WiMAX network 400 via WiMAX base stations 404 and/or CDMA network 410 via CDMA base stations 402.

In some scenarios, the multimode MS may be in an idle mode in both the WiMAX and the CDMA 1xRTT (or UMTS) networks. The multimode MS may listen for traffic indication or paging messages in both networks. The time interval to listen to paging messages may be a defined duration (e.g., paging interval) over a periodic paging cycle.

Different networks may have different paging interval durations, as shown in the following examples. In WiMAX networks, a Paging Listening Interval may be a maximum of 5 frames over a configurable Paging Cycle (in frames). In CDMA 1x network, the interval may be 180 milliseconds (ms) to cover Quick Paging Channel (CH) and Paging CH over a configurable Slotted Paging Cycle=1.28 seconds*2^{SLOT}^{_{—}}^{CYCLE}^{_{—}}^{INDEX}. In CDMA Evolution-Data Optimized (EVDO) Revision 0 network, one control channel cycle may be equal to 426.67 ms over a constant Paging Cycle (e.g., 5.12 seconds). In CDMA EVDO Rev A networks, one control channel cycle may be equal to 426.67 ms over a configured Paging Cycle (e.g., 3/1.67 milliseconds Period). In UMTS networks, a cycle may be 22 ms to cover Paging Indicator channel and one Paging Channel frame over a configurable DRX (Discontinuous Reception) Cycle (2³, 2⁴, 2⁵, 2⁶, 2⁷, 2⁸, and 2⁹ frames).

If a MS may only listen to one network at a time, when paging intervals for two networks such as WiMAX and CDMA (or UMTS) overlap, a paging interval conflict may happen. Therefore, the MS may select a network and listen to the paging messages of the selected network.

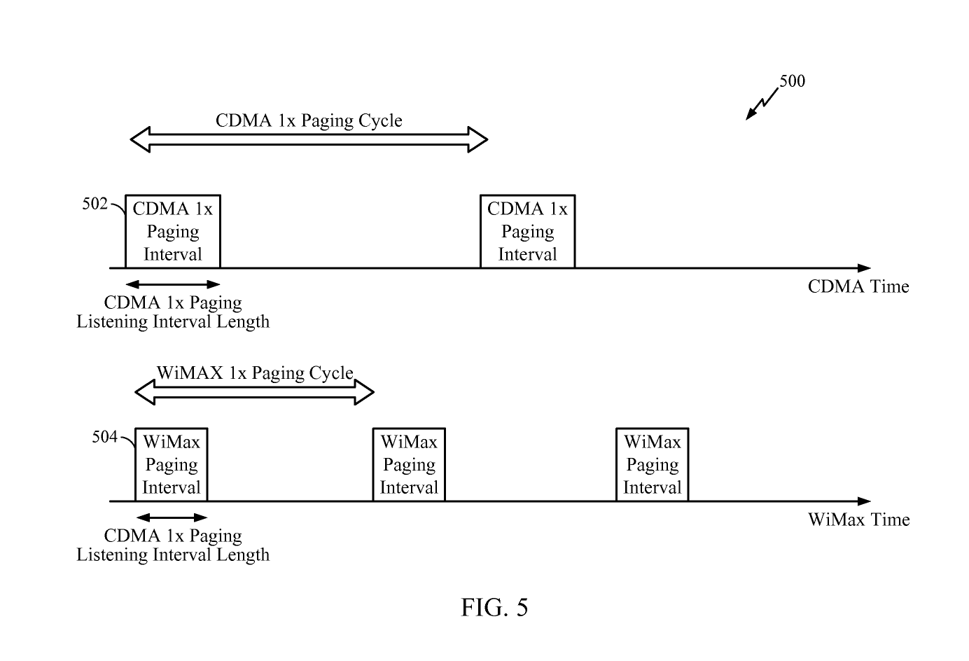

FIG. 5 illustrates an example paging interval conflict between paging interval of a WiMAX network and paging interval of a CDMA network, in accordance with certain aspects of the present disclosure. As illustrated, the paging interval of the CDMA network 502 overlaps with the paging interval of the WiMAX network 504. For certain aspects, the multi-mode MS may select one of the networks to monitor. For another aspect, the multimode MS may split its resources (if possible) to monitor both networks simultaneously.

The paging interval conflict may be due to lack of coordination in paging offsets between the two networks. Certain aspects of the present disclosure propose enhancements to a multimode MS to resolve paging conflict and to avoid missing paging messages.

Methods and systems are described herein to resolve paging conflicts among multiple RATs. A multimode MS may listen to paging signals of one or more RATs simultaneously. For example, a WiMAX multimode MS may have two antennas and two radio frequency (RF) receive chains in a MIMO configuration. For certain aspects, if the MIMO hardware is capable of independently tuning to different frequency bands and channels, the MIMO resources may be divided between the two RATs such that the mobile station uses a portion of the MIMO resources to listen to the paging signals of the WiMAX network and another portion of the MIMO resources to listen to the paging signals of the CDMA (or UMTS) network to avoid conflicts. Therefore, the MIMO resources may be split between the two RATs for listening to the paging messages. Although the above example refers to a multimode MS with two receive chains, one skilled in the art would recognize that the multimode MS may have any number of antennas and receive chains and may split its resources among two or more RATs, without departing from the scope of the present disclosure.

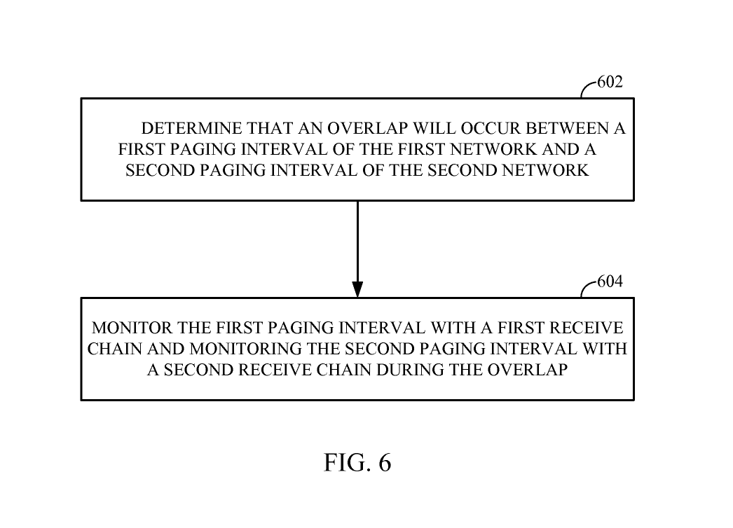

FIG. 6 illustrates example operations that may be executed to schedule monitoring of paging intervals in a multimode mobile station that can tune to different frequencies, whenever there is a conflict between paging intervals of two different networks, in accordance with certain aspects of the present disclosure. Operations illustrated by the blocks 600 may be executed, for example, at the processor 204 of the wireless device 202 from FIG. 2. The operations may begin at block 602 by determining that an overlap will occur between a first paging interval of the first network and a second paging interval of the second network. At 604, the multimode MS may monitor the first paging interval with a first receive chain and monitor the second paging interval with a second receive chain during the overlap.

For certain aspects, if the MS knows that the current paging interval for the first RAT may have conflict with the paging interval of the second RAT, the MS may split its available MIMO resources and only use the first set of MIMO resources to listen to the paging messages in the first RAT. Also, the MS may keep the second set of MIMO resources in standby mode (or a powered down state) and prepare to use the second set of MIMO resources to listen to the paging messages of the second RAT as soon as the paging messages of the second RAT start.

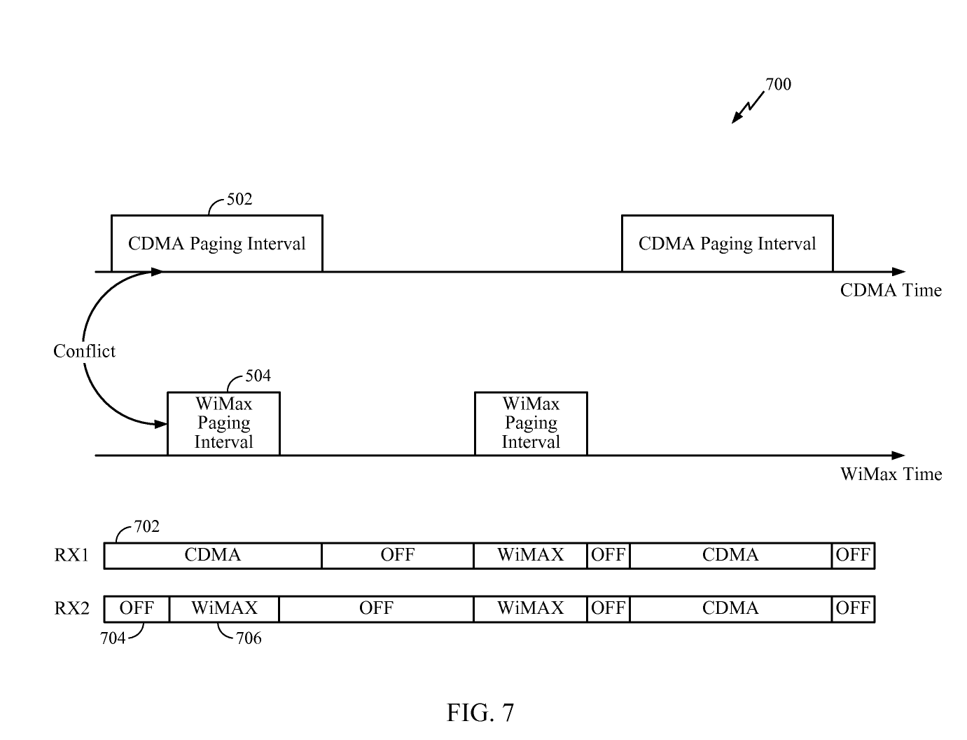

FIG. 7 illustrates an example paging interval conflict resolution by splitting MIMO resources between two networks when a paging conflict is about to happen, in accordance with certain aspects of the present disclosure. As illustrated, the receive (RX) chains may be split into two portions to allow listening to the paging messages in the two networks. For example, the first receive chain may be used to monitor CDMA network 702 and the second receive chain may be in powered down mode (e.g., 704) to be used at a later time. As soon as the paging interval of the WiMAX network starts, the second receive chain may be used to monitor the WiMAX network (e.g., 706). For certain aspects, if there are no conflicts, the two RX chains may be used to listen to only one network to provide receive diversity.

For certain aspects, the multimode MS may use its resources more aggressively although it is aware of the paging interval conflict between the two networks. For example, the MS may continue to use all of its available MIMO resources for reception of paging messages of the first RAT (to provide receive diversity) until the paging interval of the second RAT is about to start. When the paging interval of the second RAT starts, the MS may split the MIMO resources and use different resources to listen to the first and the second RATs (e.g., use a first receive chain to listen to the first RAT and a second receive chain to listen to the second RAT).

For certain aspects, when one of the paging intervals of the two networks ends, some or all of the MIMO resources may be used for listening to the paging signals of the network whose paging interval is not finished yet.

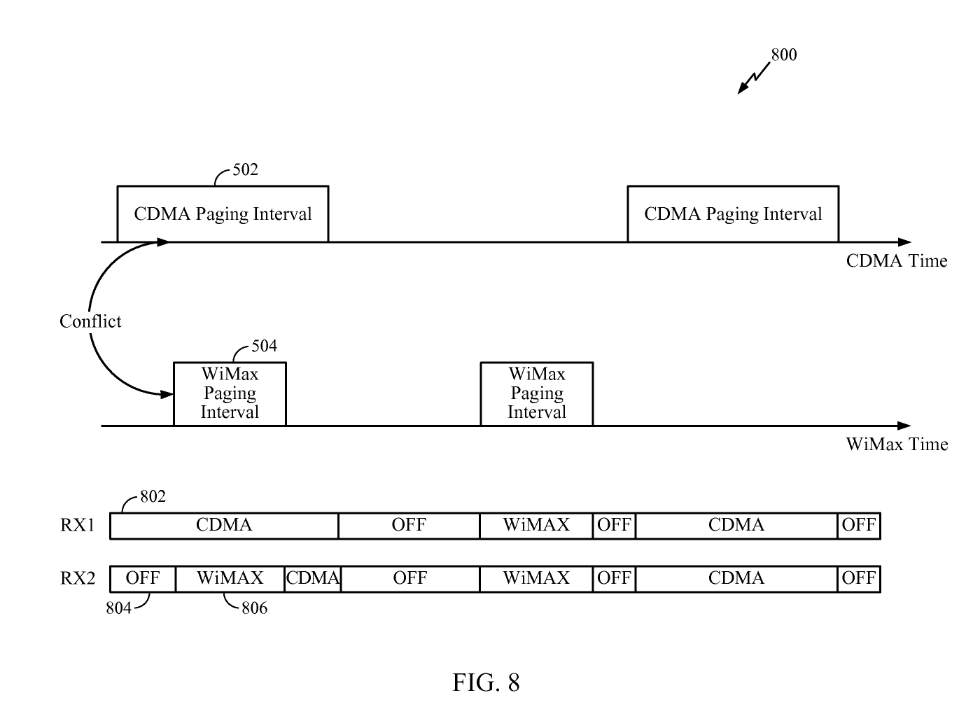

FIG. 8 illustrates an example paging interval conflict resolution by splitting MIMO resources between two networks after a paging conflict happens, in accordance with certain aspects of the present disclosure. In this example, the multimode MS uses the first receive chain to receive CDMA signals 802. The second receive chain also receives CDMA signals 804 up to the time that the paging interval of the WiMAX network starts. As soon as the paging interval of the WiMAX network starts, the MS splits its MIMO resources and uses the first receive chain to receive CDMA signals 802 and the second receive chain to receive WiMAX signals 806.

In some cases MIMO resources of a multimode MS can not independently tune to different frequencies. For example, it may not be possible to tune the first receive chain of the multimode MS to a first frequency (e.g., for a first RAT) while tuning the second receive chain of the multimode MS to a second frequency (e.g., for a second RAT).

For certain aspects, the UE may select one of the networks and monitor paging intervals of the selected network based on one or more of the following metrics.

In some cases, the network whose paging interval starts earlier may be selected as the one to monitor or the network whose paging interval ends earlier may be selected as the one to monitor.

In some cases, the network with better signal quality may be selected as the one to monitor. For example, a network with a better carrier-to-interference-plus-noise ratio (CINR) or a better received signal strength indication (RSSI) may be selected using pilot signals associated with the network.

In some cases, a network with a larger paging cycle may be selected as the one to monitor. In some cases, a network that has not yet been selected to monitor in the previous paging interval conflict may be selected as the one to monitor.

In some cases, a network with a higher RAT-based priority may be selected as the one to monitor. As an example, an MS may be configured to monitor a WiMAX network over CDMA (or UMTS) if there is a conflict.

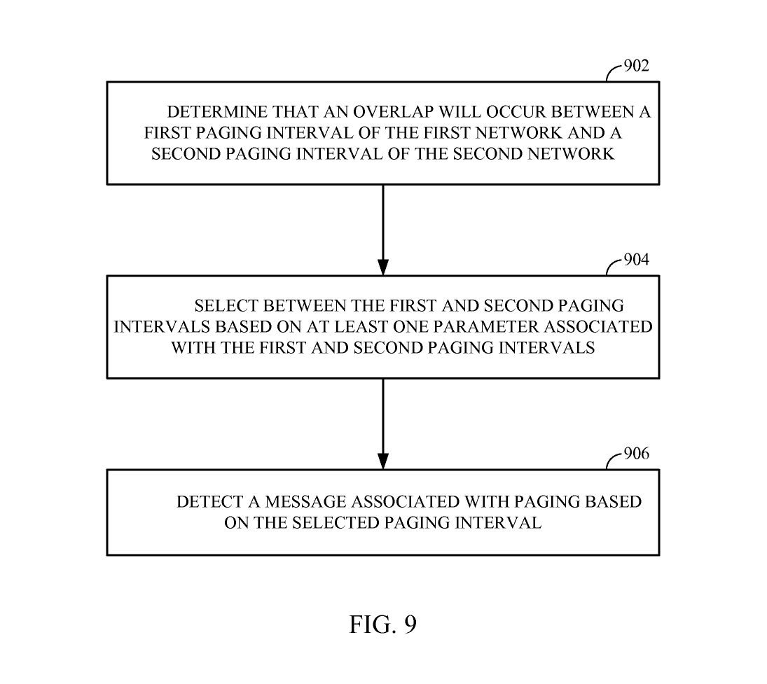

FIG. 9 illustrates example operations that may be executed to schedule monitoring of paging intervals in a multimode mobile station, whenever there is a conflict between paging intervals of two different networks, in accordance with certain aspects of the present disclosure. At 902, the multimode MS may determine that an overlap will occur between a first paging interval of the first network and a second paging interval of the second network. At 904, the multimode MS may select between the first and second paging intervals based on at least one parameter associated with the first and second paging intervals. For example, the multimode MS may select a network whose paging interval starts earlier. At 906, the multimode MS may detect a message associated with paging based on the selected paging interval.

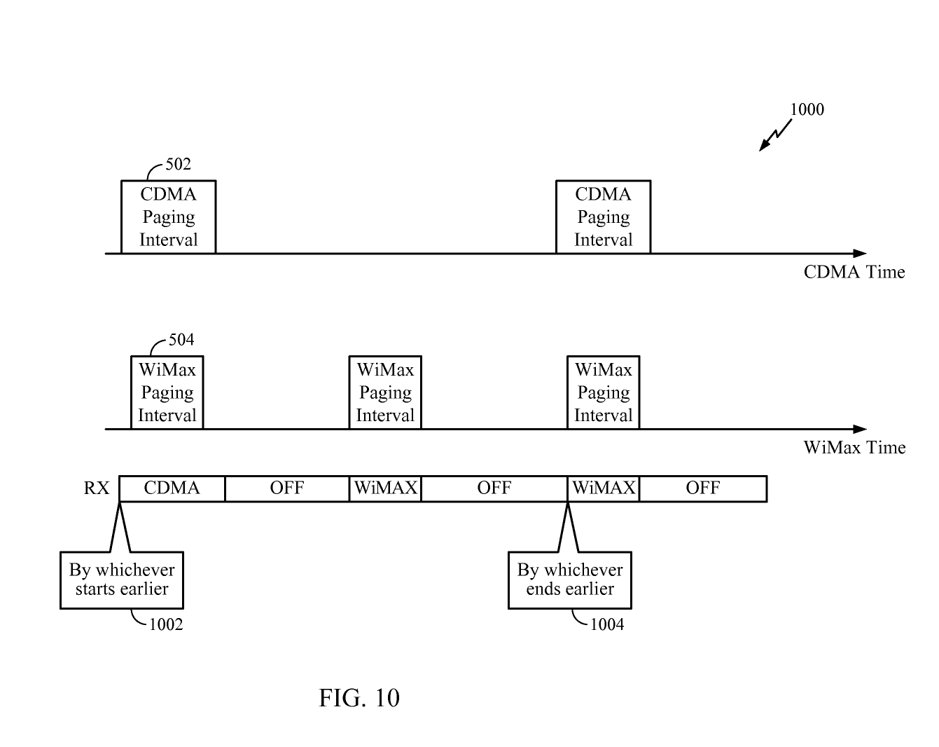

FIG. 10 illustrates scheduling a paging interval during a paging interval conflict between two different networks based on paging interval of a network that starts earlier (or ends earlier), in accordance with certain aspects of the present disclosure. In this example, the multimode MS selects the CDMA network (e.g., 1002) whose paging interval starts earlier than the paging interval of the WiMAX network. The multimode MS may also select the WiMAX network (e.g., 1004) whose paging interval ends earlier than the paging interval of the CDMA network.

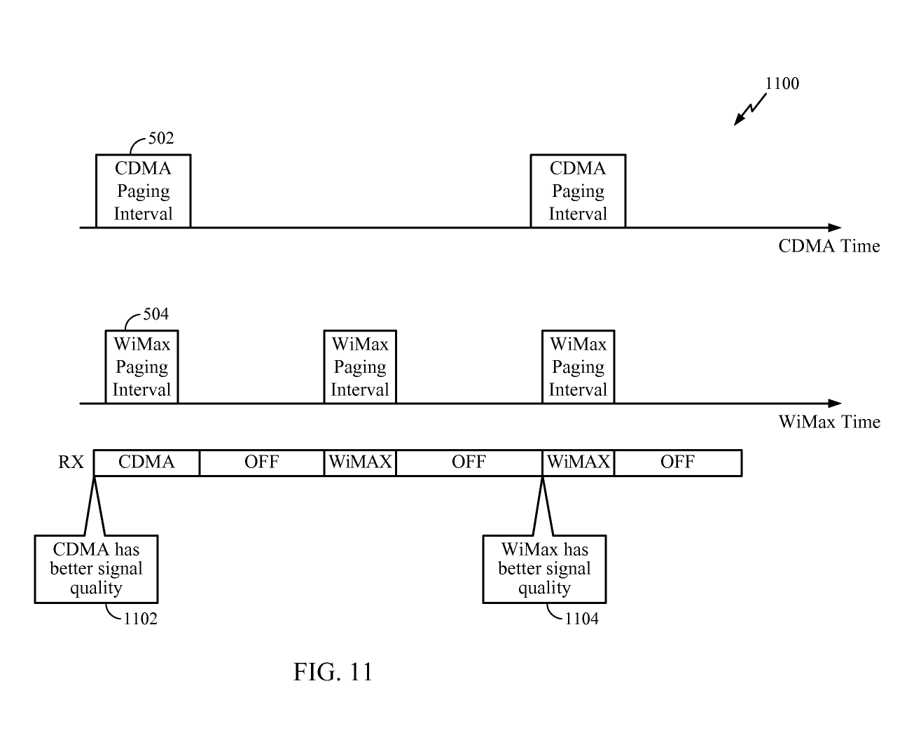

FIG. 11 illustrates scheduling a paging interval during a paging interval conflict between two different networks based on signal quality of the networks, in accordance with certain aspects of the present disclosure. In this example, the multi-mode MS selects the CDMA network (e.g., 1102) when the CDMA network has better signal quality than the WiMAX network. The multi-mode MS may also select the WiMAX network (e.g., 1104) if the WiMAX network has better signal quality than the CDMA network.

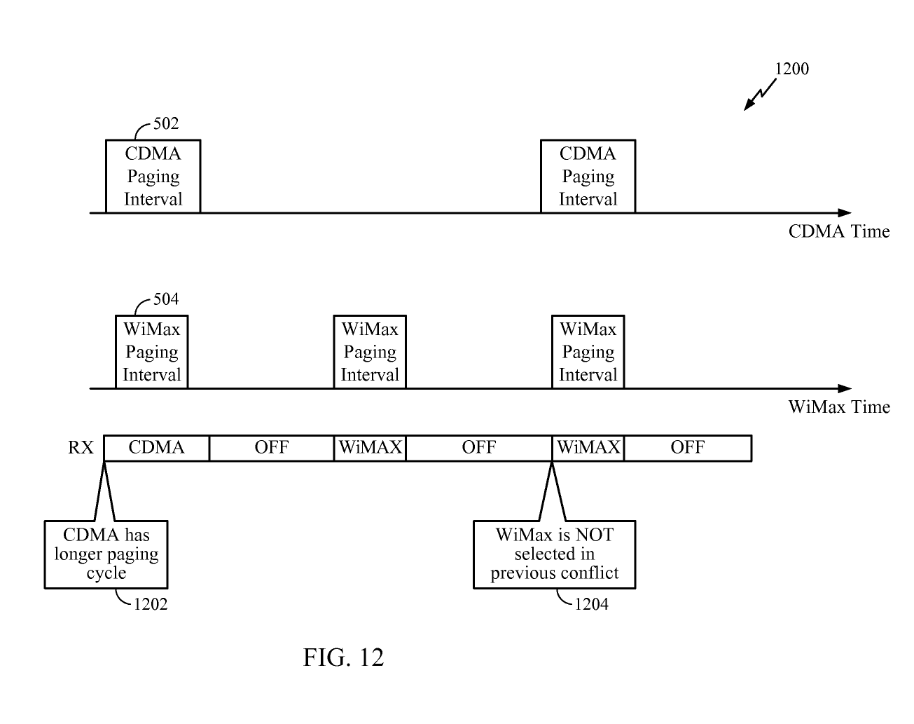

FIG. 12 illustrates scheduling a paging interval during a paging interval conflict between two different networks by selecting a network that has longer paging cycle or a network that was not been selected during a previous paging interval conflict, in accordance with certain aspects of the present disclosure. In this example, the multi-mode MS selects the CDMA network (e.g., 1202) when the CDMA network has longer paging cycle than the WiMAX network. The multi-mode MS may also select the WiMAX network (e.g., 1204) if the WiMAX network was not selected in a previous paging interval conflict.

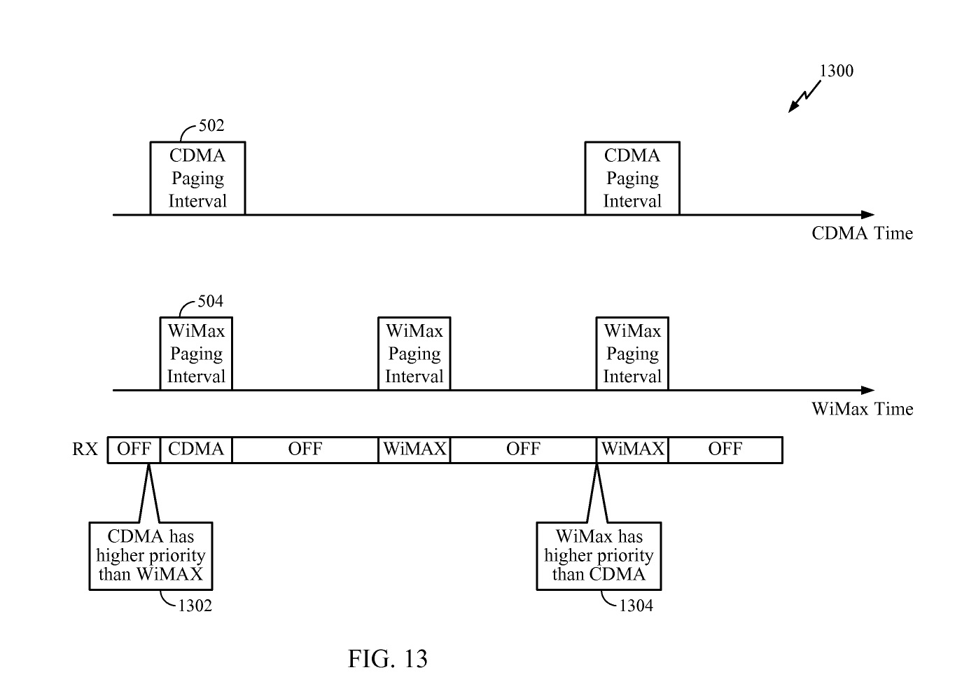

FIG. 13 illustrates scheduling a paging interval during a paging interval conflict between two different networks based on RAT-based priorities of the networks, in accordance with certain aspects of the present disclosure. In this example, the multi-mode MS selects the CDMA network (e.g., at 1302) when the CDMA network has higher priority than the WiMAX network. The multi-mode MS may also select the WiMAX network (e.g., at 1304) if the WiMAX network has higher priority than the CDMA network.

For certain aspects, the MS may tune its receive chains to receive signals of the other network before the conflicting time duration starts or after the conflicting time duration ends. For example, when the UE is monitoring the network with earlier starting point, if one of the paging intervals finishes, the MS may tune to the other network and monitor the paging signals of the other network in the remaining portion of its paging interval.

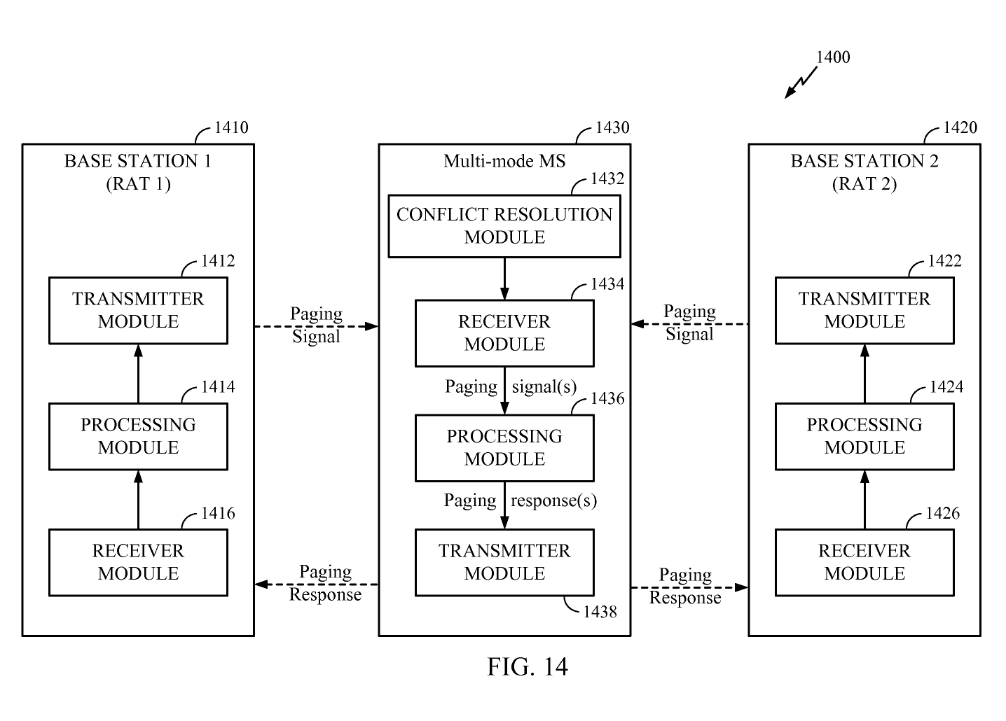

FIG. 14 illustrates an example communication system 1400, in accordance with certain aspects of the present disclosure. As illustrated, the communication system may include a first base station (e.g., base station1 1410) for a first RAT (e.g., WiMAX) and a second base station (e.g., base station2 1420) for a second RAT (e.g., CDMA), and a multimode MS 1430. The base stations may transmit paging signals to the multimode MS using the transmitter modules 1412 and 1422. The multimode MS may receive the paging signals from both base stations with a receiver module 1434. In case of a paging interval overlap between the two RATs, a conflict resolution module 1432 may resolve the paging conflict by either selecting one of the networks to monitor, or splitting the MIMO resources of the multimode MS to monitor both networks simultaneously. The receiver module 1434 may monitor and detect the paging signals transmitted by the two networks. A processing module 1436 may process the paging signals that are received from the networks and generate paging response messages. A transmitter module 1438 may transmit the paging response messages to the base stations. The base stations 1410 and 1420 may receive the paging response messages by receiver modules 1416 and 1426, and process the paging response messages with processing modules 1414 and 1424.

As described herein, aspects of the present disclosure may enable a multi-mode MS to split its MIMO resources and simultaneously monitor the paging messages of two or more networks (e.g., WiMAX and CDMA (or UMTS)), if the RX chains in MIMO can independently tune to different frequencies. For certain aspects, the multi-mode MS may choose one of the conflicting paging intervals to monitor if the RX chains in MIMO cannot independently tune to different frequencies.

As described herein, means for determining that an overlap will occur between a first paging interval of the first network and a second paging interval of the second network may comprise any suitable circuit or processor, such as the conflict resolution module 1432 as illustrated in FIG. 14. Means for selecting between the first and second paging intervals may include any suitable circuit or processor, such as the conflict resolution module 1432 as illustrated in FIG. 14. Means for detecting a message associated with paging based on the selected paging interval may comprise a detector such as the signal detector 218 as illustrated in FIG. 2, or the receiver module 1434 as illustrated in FIG. 14. Means for monitoring a paging interval may comprise a receiver such as the receiver module 1434.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for communicating, by a multi-mode mobile station (MS), with first and second networks via first and second radio access technologies (RATs), respectively, the method comprising:
determining that an overlap will occur between a first paging interval of the first network and a second paging interval of the second network;
selecting between the first and second paging intervals based on at least one parameter associated with the first and second paging intervals; and
detecting a message associated with paging based on the selected paging interval.

2. The method of claim 1, wherein the at least one parameter comprises a starting time of the first and second paging intervals such that the selected paging interval is the first or the second paging interval with an earlier starting time.

3. The method of claim 1, wherein the at least one parameter comprises an ending time of the first and second paging intervals such that the selected paging interval is the first or the second paging interval with an earlier ending time.

4. The method of claim 1, wherein the at least one parameter comprises a signal quality of the first and second paging intervals such that the selected paging interval is the first or the second paging interval with a better signal quality.

5. The method of claim 4, wherein the signal quality of the first and second paging intervals comprises a carrier-to-interference-plus-noise ratio (CINR) or a received signal strength indication (RSSI) determined from a pilot signal associated with one of the first and second paging intervals.

6. The method of claim 1, wherein the at least one parameter comprises duration of first and second paging cycles such that the selected paging cycle is the first or the second paging cycle with a longer duration.

7. The method of claim 1, wherein the at least one parameter comprises a selected network of a previously selected paging interval such that the selected paging interval is the first or the second paging interval of either the first network or the second network, respectively, that is different from the previously selected paging interval's network.

8. The method of claim 1, wherein the at least one parameter comprises a RAT-based priority of the first and second paging intervals such that the selected paging interval is the first or the second paging interval with a higher RAT-based priority.

9. The method of claim 8, wherein the multi-mode MS is configured with the RAT-based priority.

10. The method of claim 1, further comprising detecting the message associated with paging from the first network when the first paging interval of the first network does not overlap with the second paging interval.

11. The method of claim 1, wherein the multi-mode MS comprises first and second receive chains configurable for multiple input multiple output (MIMO).

12. The method of claim 11, wherein the first and second receive chains cannot be tuned to different frequency bands.

13. A method for communicating, by a multi-mode mobile station (MS), with first and second networks via first and second radio access technologies (RATs), respectively, the method comprising:
determining that an overlap will occur between a first paging interval of the first network and a second paging interval of the second network; and
monitoring the first paging interval with a first receive chain and monitoring the second paging interval with a second receive chain during the overlap.

14. The method of claim 13, further comprising:
monitoring the first or the second paging interval using both the first and second receive chains when there is no overlap.

15. The method of claim 13, further comprising:
powering down the first and second receive chains in an idle mode without the first or the second paging interval.

16. The method of claim 13, wherein monitoring the first paging interval with the first receive chain and monitoring the second paging interval with the second receive chain comprises:
using the first receive chain to monitor paging signals of the first network while keeping the second receive chain in a powered down state if the second paging interval starts later than the first paging interval.

17. The method of claim 13, further comprising:
using both the first and the second receive chains to monitor paging signals of the first network during the first paging interval until the second paging interval of the second network is about to start; and
after paging interval of the first or the second network ends, using both the first and the second receive chains to monitor the first or the second network whose paging interval has not finished yet.

18. The method of claim 13, wherein the first or the second receive chain comprises one or more antennas.

19. The method of claim 13, wherein the first and second receive chains are associated with different frequency bands.

20. An apparatus for communicating, with first and second networks via first and second radio access technologies (RATs), respectively, the apparatus comprising:
means for determining that an overlap will occur between a first paging interval of the first network and a second paging interval of the second network;
means for selecting between the first and second paging intervals based on at least one parameter associated with the first and second paging intervals; and
means for detecting a message associated with paging based on the selected paging interval.

21. The apparatus of claim 20, wherein the at least one parameter comprises a starting time of the first and second paging intervals such that the selected paging interval is the first or the second paging interval with an earlier starting time.

22. The apparatus of claim 20, wherein the at least one parameter comprises an ending time of the first and second paging intervals such that the selected paging interval is the first or the second paging interval with an earlier ending time.

23. The apparatus of claim 20, wherein the at least one parameter comprises a signal quality of the first and second paging intervals such that the selected paging interval is the first or the second paging interval with a better signal quality.

24. The apparatus of claim 23, wherein the signal quality of the first and second paging intervals comprises a carrier-to-interference-plus-noise ratio (CINR) or a received signal strength indication (RSSI) determined from a pilot signal associated with one of the first and second paging intervals.

25. The apparatus of claim 20, wherein the at least one parameter comprises duration of first and second paging cycles such that the selected paging cycle is the first or the second paging cycle with a longer duration.

26. The apparatus of claim 20, wherein the at least one parameter comprises a selected network of a previously selected paging interval such that the selected paging interval is the first or the second paging interval of either the first network or the second network, respectively, that is different from the previously selected paging interval's network.

27. The apparatus of claim 20, wherein the at least one parameter comprises a RAT-based priority of the first and second paging intervals such that the selected paging interval is the first or the second paging interval with a higher RAT-based priority.

28. The apparatus of claim 27, wherein the apparatus is configured with the RAT-based priority.

29. The apparatus of claim 20, further comprising:
means for detecting the message associated with paging from the first network when the first paging interval of the first network does not overlap with the second paging interval.

30. The apparatus of claim 20, wherein the apparatus comprises first and second receive chains configurable for multiple input multiple output (MIMO).

31. The apparatus of claim 30, wherein the first and second receive chains cannot be tuned to different frequency bands.

32. An apparatus for communicating, with first and second networks via first and second radio access technologies (RATs), respectively, the apparatus comprising:
means for determining that an overlap will occur between a first paging interval of the first network and a second paging interval of the second network; and
means for monitoring the first paging interval with a first receive chain and monitoring the second paging interval with a second receive chain during the overlap.

33. The apparatus of claim 32, further comprising:
means for monitoring the first or the second paging interval using both the first and second receive chains when there is no overlap.

34. The apparatus of claim 32, further comprising:
means for powering down the first and second receive chains in an idle mode without the first or the second paging interval.

35. The apparatus of claim 32, wherein the means for monitoring the first paging interval with the first receive chain and monitoring the second paging interval with the second receive chain comprises:
means for using the first receive chain to monitor paging signals of the first network while keeping the second receive chain in a powered down state if the second paging interval starts later than the first paging interval.

36. The apparatus of claim 32, further comprising:
means for using both the first and the second receive chains to monitor paging signals of the first network during the first paging interval until the second paging interval of the second network is about to start; and
means for using both the first and the second receive chains, after paging interval of the first or the second network ends, to monitor the first or the second network whose paging interval has not finished yet.

37. The apparatus of claim 32, wherein the first or the second receive chain comprises one or more antennas.

38. The apparatus of claim 32, wherein the first and second receive chains are associated with different frequency bands.

39. A computer-program product for communicating, by a multimode mobile station (MS) with first and second networks via first and second radio access technologies (RATs), respectively, the computer-program product comprising a non-transitory computer readable medium having instructions stored thereon, the instructions being executable by one or more processors and the instructions comprising:
instructions for determining that an overlap will occur between a first paging interval of the first network and a second paging interval of the second network;
instructions for selecting between the first and second paging intervals based on at least one parameter associated with the first and second paging intervals; and
instructions for detecting a message associated with paging based on the selected paging interval.

40. A computer-program product for communicating, by a multimode mobile station (MS) with first and second networks via first and second radio access technologies (RATs), respectively, the computer-program product comprising a non-transitory computer readable medium having instructions stored thereon, the instructions being executable by one or more processors and the instructions comprising:
instructions for determining that an overlap will occur between a first paging interval of the first network and a second paging interval of the second network; and
instructions for monitoring the first paging interval with a first receive chain and monitoring the second paging interval with a second receive chain during the overlap.

41. An apparatus for communicating with first and second networks via first and second radio access technologies (RATs), respectively, the apparatus comprising at least one processor configured to:
determine that an overlap will occur between a first paging interval of the first network and a second paging interval of the second network,
select between the first and second paging intervals based on at least one parameter associated with the first and second paging intervals, and
detect a message associated with paging based on the selected paging interval; and
a memory coupled to the at least one processor.

42. An apparatus for communicating with first and second networks via first and second radio access technologies (RATs), respectively, the apparatus comprising at least one processor configured to:
determine that an overlap will occur between a first paging interval of the first network and a second paging interval of the second network, and
monitor the first paging interval with a first receive chain and monitoring the second paging interval with a second receive chain during the overlap; and
a memory coupled to the at least one processor.
